(19) United States
(12) Patent Application Publication
(10) Pub. No.: US 2013/0108030 A1
(43) Pub. Date: May 2, 2013

(54) System and Method for Creating Parallel Graphical Interface for Voice Menu

(71) Applicants: Shamir Shmuel Snir, Kadima (IL); Shimshon Nagar, Netanya (IL)

(72) Inventors: Shamir Shmuel Snir, Kadima (IL); Shimshon Nagar, Netanya (IL)

(21) Appl. No.: 13/660,208

(22) Filed: Oct. 25, 2012

Related U.S. Application Data
(60) Provisional application No. 61/552,098, filed on Oct. 27, 2011.

(51) Int. Cl. H04M 1/64

(52) U.S. Cl. 379/88.01

(57) ABSTRACT

A method of creating a parallel graphical interface in addition to a voice menu by an application that is running on a computerized mobile device during a phone call. When a user is initiating a phone call by the computerized mobile device to an operator, the application is recognizing the number and associating an Interactive Voice Response (IVR) code with the operator. After a session is created between the application and the operator, a parallel graphical interface is created in addition to a voice menu, according to the IVR code. The graphical interface is presented on the screen of the computerized mobile device while running the voice menu. Activity of the voice menu is synchronized with the activity of the graphical interface so the user may select options from at least one of: (i) voice menu; and (ii) graphical interface, to navigate through the IVR code. The options that were selected are transmitted to the operator.

### BACKGROUND

1. Technical Field

The present invention relates generally to an application that is running on a computerized mobile device and allows processing of an Interactive Voice Response (IVR) code.

2. Discussion of Related Art

Several solutions exist in the market for creating a graphical interface in addition to a voice menu during a phone call from a mobile device. Some of the solutions utilize external computers in addition to the mobile device to navigate the graphical interface; other solutions are based on dial-tone multi-frequency signaling technology for emulation of option selections in the menu. Thus, allowing changes in the menu only on an operator of Public Switch Telephone Network (PSTN) or Public Branch Exchange (PBX) and not on an application that is running on the mobile device.

### BRIEF SUMMARY

According to some embodiments of the present invention methods and systems for supplementing voice menu with a graphical interface by an application that is running on a computerized mobile device (i.e. Smartphone) is provided herein. Additionally, the present invention may activate an application that is running on the Smartphone, by at least one of: (i) selecting the application; and (ii) initiating a phone call by a Smartphone to an operator. The operator may be at least one of: (i) Public Switch Telephone Network (PSTN); (ii) Public Branch Exchange (PBX); and (iii) Internet Protocol (IP) PBX. The application may associate the operator with an Interactive Voice Response (IVR) code by at least one of: (i) connecting to the operator; and (ii) retrieving the IVR from a database that is connected to the application.

According to some embodiments of the invention, the present invention provides creation of a session between the application and the operator and addition of a graphical interface to the voice menu according to the IVR code. Furthermore, the present invention may present the graphical interface on the Smartphone while running a voice menu according to the IVR code. The voice menu may be synchronized with the graphical interface so a selection of an option may be performed from at least one of: (i) voice menu; and (ii) graphical interface, to navigate through the IVR code or interact by method of free text or speech.

According to some embodiments of the present invention, the option that was selected is transmitted to the operator and entered data or saved data from the application is transferred to the operator. Also, a chat with a service provider may be operated via the application, and may be at least one of: video chat, text chat and voice chat.

According to yet some other embodiments of the present invention, after initiation of a phone call via the Smartphone to an operator, the application in the present invention may examine a number that was dialed and determine its associate IVR code.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1A is a high level schematic block diagram of a system for creating a parallel graphical interface in addition to a voice menu, according to some embodiments of the invention;

FIG. 1B is a high level schematic block diagram of a system for creating a parallel graphical interface in addition to a voice menu when an Interactive Voice Response (IVR) code exists on an application that is running on Smartphone, according to some embodiments of the invention;

FIG. 2 is a high level flowchart illustrating an activity of the application that is running on Smartphone, according to some embodiments of the invention;

FIG. 3A is an explanatory diagram of a graphical interface of a voice menu that is running on a Smartphone, according to some embodiments of the invention; and

FIG. 3B is an explanatory diagram of a graphical interface of a voice menu that is running on a Smartphone, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology implemented herein are for the purpose of description and should not be regarded as limiting.

For a better understanding of the invention, the usages of the following terms in the present disclosure are defined in a non-limiting manner:

The term “Interactive Voice Response (IVR)” as used herein in this application, is defined as a code running on a computer of an operator and enables the computer to interact with a caller by using voice and dial-tone multi-frequency signals entered via telephone keypads.

The term “Public Switch Telephone Network (PSTN)” as used herein in this application, is defined as telephone network consists the following components telephone lines, fiber optic cables, microwave transmission links, cellular networks, communications satellites, and undersea telephone cables. The components are interconnected by switching centers.

The term “Public Branch Exchange (PBX)” as used herein in this application, is defined as a telephone operator that serves a specific business.

The term “Internet Protocol (IP) PBX” as used herein in this application, is defined as a Voice Over Internet Protocol (VoIP) PBX that uses the internet protocol to place phone calls.

The term “Smartphone” as used herein in this application, is defined as a computerized mobile device with advanced computer abilities and connectivity. It is a combination of a personal computer and a mobile phone.

The term “interface” as used herein in this application, is a tool and concept that refers to a point of interaction between components in one or multiple instances of an application.

Embodiments of the present invention provide methods and systems to add a parallel graphical interface to a voice menu by an application that is running on a Smartphone. The present invention utilizes a graphical interface in addition to a voice menu which is invoked during a phone call, by either the PSTN operator or the PBX operator to route a caller to a requested party or searched information. The PBX operator may be an Internet Protocol (IP) PBX.

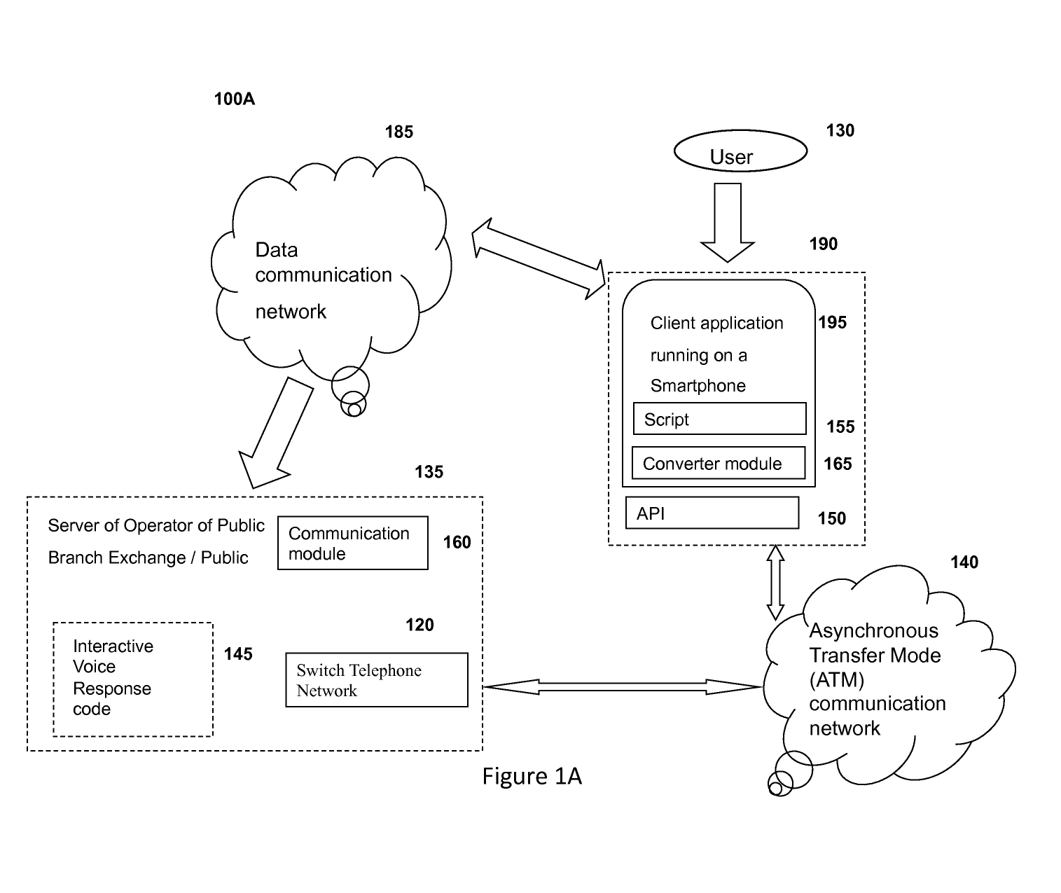

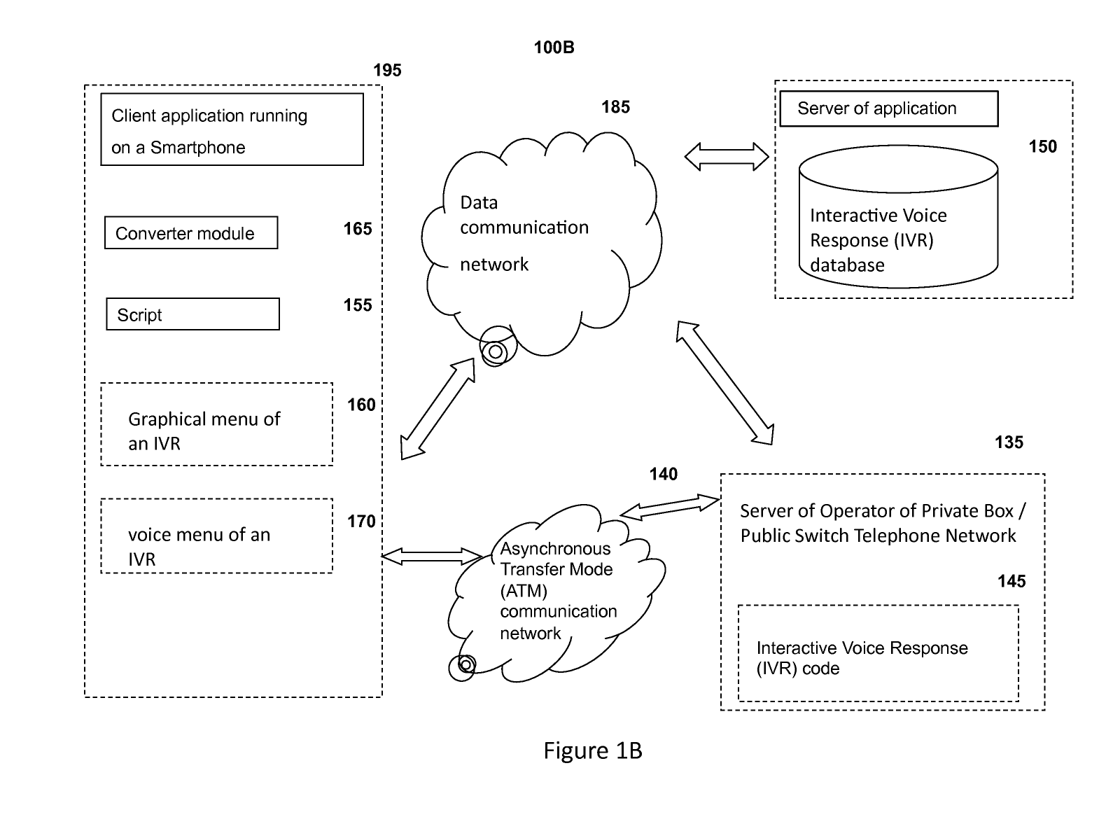

FIG. 1A is a high level schematic block diagram of a system for creating a parallel graphical interface in addition to a voice menu, according to some embodiments of the invention;

In a non-limiting example, a user 130 may initiate a phone call using a Smartphone 190 (i.e. computerized mobile device) via data communication network such as Asynchronous Transfer Mode (ATM) communication 140. The user may initiate a phone call to a company that is selling computer equipment, regarding a serial code of a license of software that he or she had purchased. The user 130 may wish to speak with a service representative regarding that issue. According to an aspect of the present invention, the user 130 may initiate the phone call by at least one of: (i) selecting an application 195 on the Smartphone 190; (ii) dialing the phone number of the company.

In case the user 130 dials the phone number of the company, the application 195 may examine the phone number and determine whether it has to be invoked during that phone call. The application 195 may be invoked by triggering a built-in API 150 during the phone call if the triggered API identifies the phone number as related to a company that operates an IVR code and utilizes an interface for a graphical interface.

For entering VOIP calls, for example from Skype™ there is no triggering API 150 therefore an additional module should be added to the Smartphone to invoke application 195.

According to an aspect of the present invention, the application 195 that is running on the Smartphone 190 of the user 130 may associate an IVR code 145 that is running on a server to the operator 135 of the company that is selling computer equipment via a data communication network 185. The operator 135 may be at least one of: (i) Public Switch Telephone Network (PSTN) 120; and (ii) a Public Branch Exchange (PBX) (not shown).

According to another aspect of the present invention, the application 195 may initiate a session between the application 195 and the server of operator 135 of the company utilizing communication module 160 that is selling computer equipment. A graphical interface may be presented on the screen of the Smartphone 190 according to the Interactive Voice Response IVR code 145 while an associate voice menu is being audible. The graphical interface may be built from a script 155 that is stored on the Smartphone 190 by a converter module 165. A wizard may enable change of attributes of the graphical interface such as colors, screen design etc. An additional module may update the graphical interface. Activity of the voice menu may be synchronized with the activity of the graphical interface, until user 130 is routed to his or her requested destination.

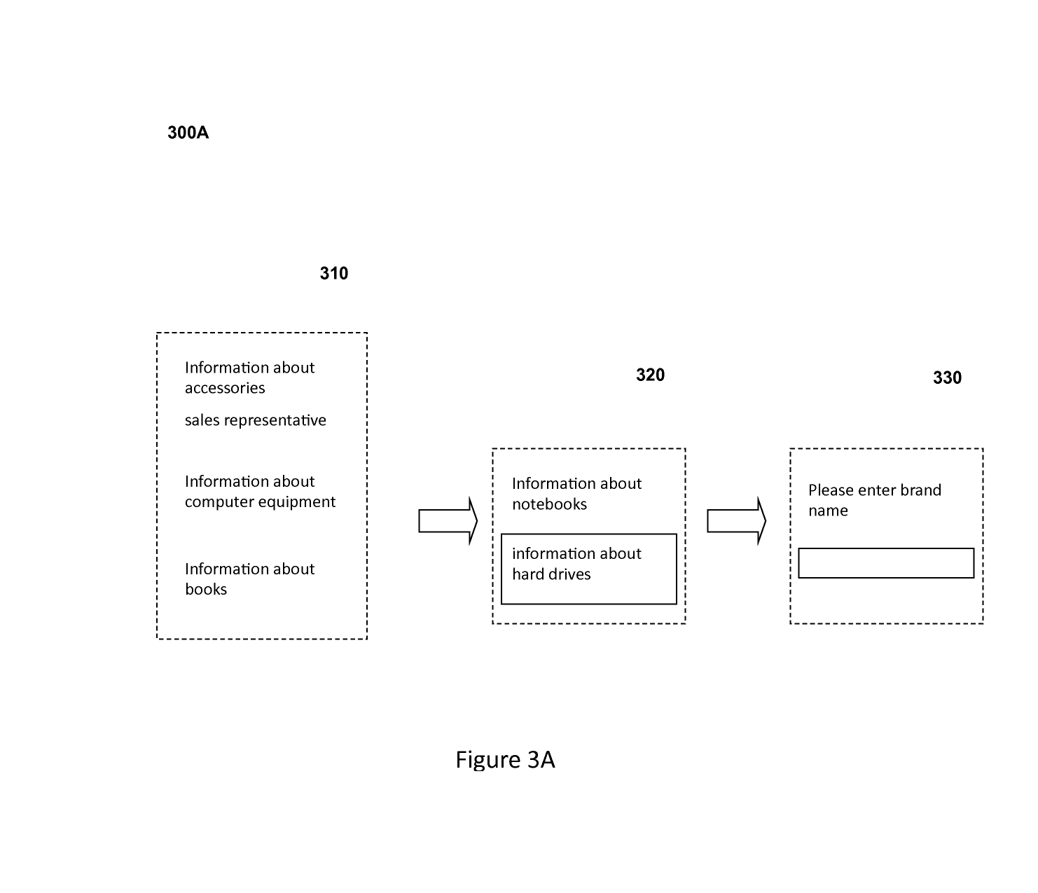

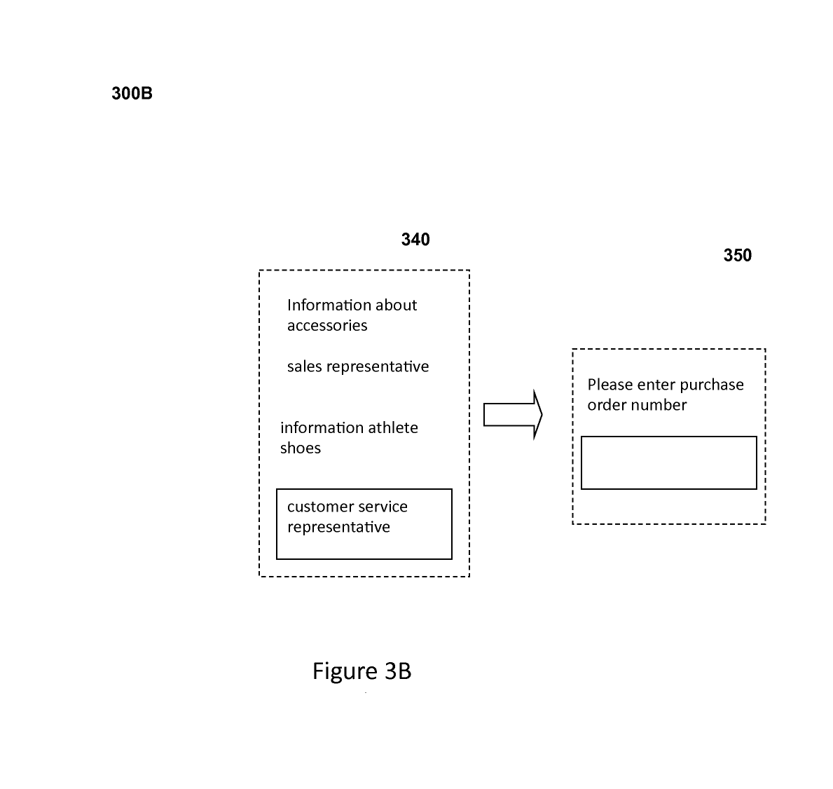

According to yet another aspect of the present invention, the user 130, may select, in a non limiting example, from either the graphical interface or the voice menu, option “information about computer equipment”. Then, the user 130 may be routed to a submenu 310 in FIG. 3A that may be displaying various options of information about computer equipment. In case the user 130 is interested in information regarding hard drives the user 130 may select option “information about hard drives” in submenu 320 in FIG. 3A. Then, the option that was selected is transmitted to the server of operator 135.

According to yet another aspect of the present invention, after the user 130 selects an option in menu 320 in FIG. 3A he may be routed to a screen 330 to enter further information. Then, data that was entered is transferred to the server of operator 135. In a non limiting example, data may be a name of a manufacturer of hard drives. Also, the data that is transferred may be typed on the fly or retrieved from the application 195. The data may be entered as text, voice or any other format.

According to yet another aspect of the present invention, in a non limiting example, the user 130 may initiate at least one of the following call methods: (i) a text chat; (ii) voice call; and (iii) video call, with a customer service representative via the application 195. The chat may be a video chat, a voice chat, a text chat or any other format of chat.

FIG. 1B is a high level schematic block diagram of a system for creating a parallel graphical interface in addition to a voice menu when IVR code exists, on an application that is running on a Smartphone, according to some embodiments of the invention.

In a non limiting example, the user 130 in FIG. 1A may initiate a phone call using a Smartphone 190 in FIG. 1A (i.e. a computerized mobile device) via data communication network such as ATM communication 140. The phone call may be to a company that is selling shoes via an online store, regarding a pair of shoes that he or she had purchased. The user 130 in FIG. 1A may wish to speak with a customer service representative regarding the pair of shoes that he or she had purchased. According to an aspect of the present invention, the user 130 in FIG. 1A may initiate the phone call by at least one of: (i) selecting an application 195 on the Smartphone 190 in FIG. 1A; and (ii) dialing a phone number of the company.

In case the user 130 in FIG. 1A dials a number of a company, the application may examine the number and determine whether it has to operate during that phone call. The application 195 may operate during the phone call if it identifies the number as related to a company that operates an IVR code.

According to an aspect of the present invention, the application 195 that is running on the Smartphone 190 in FIG. 1A of user 130 in FIG. 1A may retrieve an associate IVR code of the company that is selling shoes, which is stored in a database of IVR 150, via data communication network 185. The operator 135 of the company that is selling shoes may be at least one of: (i) Public Switch Telephone Network (PSTN) 120 in FIG. 1A; (ii) a Public Branch Exchange (PBX); and (iii) IP PBX.

According to another aspect of the present invention, the application 195 may initiate a session between the application 195 and the server of operator 135 of the company that is selling computer equipment. Then, a graphical interface 160 is displayed according to the IVR code 145 while an associate voice menu 170 is being audible. The graphical interface may be built from a script 155 of the voice menu that was received from the operator and is stored on the Smartphone 190 by a converter module 165. A wizard may enable change of attributes of the graphical interface such as colors, screen design etc. Additionally, the wizard may enable upload of new software components of interactive content such as games and applications. The interactive content may be presented to the user during waiting time for response. An additional module may update the script code and change graphical interface accordingly. Activity of the voice menu 170 is synchronized with the activity of the graphical interface 160 all the way, until the user 130 is routed to his or her requested destination.

According to yet another aspect of the present invention, the user 130 in FIG. 1A, may select “customer service representative” 340 in FIG. 3B. The option that was selected is transmitted to operator 135. Next, the user 130 in FIG. 1A may be presented with a screen 350 in FIG. 3B requesting him or her to enter purchase order number. Next, data that was entered may be transferred to the server of the operator 135. The data transferred may be typed on the fly or retrieved from the application 195. Further, the data may be entered as text, voice or any other format.

According to yet another aspect of the present invention, in a non limiting example, the user 130 may initiate a chat with a customer service representative via the application 195. The chat may be video chat, voice chat, text chat or any other format.

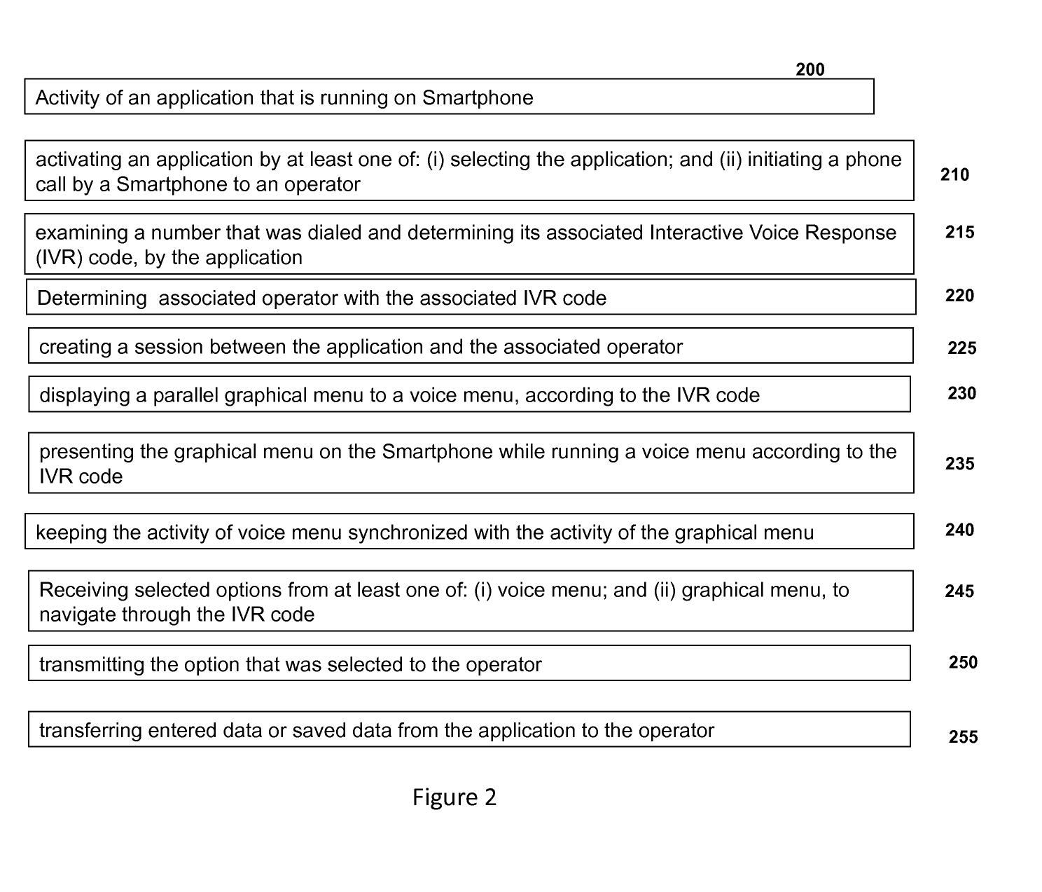

FIG. 2 is a high level flowchart illustrating an activity of an application 195 in FIG. 1A that is running on a Smartphone (i.e. computerized mobile device), according to some embodiments of the invention.

According to an aspect of the present invention, activity of the application 195 in FIG. 1 may start by at least one of: (i) selecting the application on the Smartphone; and (ii) initiating a phone call by a Smartphone to an operator of a company (stage 210). In case the user dials a phone number of a company, the application may examine the phone number and determine whether it has to operate during that phone call. The application may operate during the phone call if it identifies the phone number that was dialed as related to a company that operates an Interactive Voice Response (IVR) code (stage 215).

Next, the application may determine an associated operator with an IVR code by at least one of: (i) connecting to the server of the operator of the company; and (ii) retrieving the IVR from a database that is connected to the application (stage 220). After a session between the application and the associated operator is created (stage 225), the application may display a parallel graphical interface in addition to a voice menu that is being audible, according to the IVR code (stage 230).

According to another aspect of the present invention, the graphical interface may be presented on the Smartphone while running a voice menu according to the IVR code (stage 235). The application is keeping the activity of the voice menu synchronized with the activity of the graphical interface (stage 240) so the user may switch between usage of the voice menu and usage of the graphical interface, during the same phone call.

According to yet another aspect of the present invention, the application may receive options that the user selected from at least one of: (i) voice menu; and (ii) graphical interface, to navigate through the IVR code (stage 245). The selected options may be transmitted to the server of the operator of the company (stage 250).

According to yet another aspect of the present invention, the user may be requested to enter data, or retrieve it from the application, then the application may transfer the entered data or data that is saved in the application to the operator (stage 255).

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

1. A method of supplementing voice menu with graphical interface by an application that is running on a computerized mobile device, said method comprising the steps of:
activating an application by at least one of: (i) selecting the application; and (ii) initiating a phone call by a computerized mobile device to an operator;
associating the operator with an Interactive Voice Response (IVR) code
creating a session between the application and the operator; supplementing a voice menu according to the IVR code with a graphical interface;
presenting the graphical interface on the computerized mobile device while running a voice menu according to the IVR code;
keeping the voice menu synchronized with the graphical interface;
selecting an option
and
wherein the activating, associating, creating, supplementing, presenting, keeping, selecting, transmitting and transferring is carried out by at least one processor on the computerized mobile device.

2. The method according to claim 1, wherein the method is further comprising the step of associating the operator with an Interactive Voice Response (IVR) code by at least one of: (i) connecting to the operator; and (ii) retrieving the IVR from a database that is connected to the application.

3. The method according to claim 1, wherein the method is further comprise the step of selecting an option from at least one of: (i) voice menu; and (ii) graphical interface, to navigate through the IVR code.

4. The method according to claim 1, wherein the method is further transmitting the option that was selected to the operator.

5. The method according to claim 1, wherein the method is further transferring entered data or saved data from the application to the operator.

6. The method according to claim 1, wherein the operator is at least one of: (i) Public Switch Telephone Network (PSTN); and (ii) Public Branch Exchange (PBX).

7. The method according to claim 1, wherein the method is further enabling a chat with a service provider via the application, wherein the chat is at least one of: (i) a video chat; (ii) a text chat; and (iii) a voice chat.

8. The method according to claim 1, wherein the operator is an Internet protocol (IP) PBX.

9. The method according to claim 1, wherein the initiating of the phone call by a computerized mobile device to an operator is followed by examining a number that was dialed and determining its associate IVR code, by the application.

10. An application for supplementing voice menu with graphical interface, that is running on a computerized mobile device, said application is comprising of:
a data storage of Interactive Voice Response (IVR) codes, that is connected to the application;
a graphical interface;
a voice menu according to an IVR code;
wherein the application is associating an operator with an IVR code in the data storage by at least one of: (i) connecting to the operator; and (ii) retrieving the IVR from the data storage,
wherein the application is initiating a session between the application and the operator,
wherein the application is supplementing the voice menu according to the IVR code with the graphical interface,
wherein the application is presenting the graphical interface on a screen of the computerized mobile device while running a voice menu according to the IVR code,
wherein the application is keeping the voice menu synchronized with the graphical interface,
wherein the application is allowing a user to select an option.

11. The application of claim 10, wherein the application is further enabling a chat with a service provider via the application, wherein the chat is at least one of: (i) a video chat; (ii) a text chat; and (iii) a voice chat.

12. The application of claim 10, wherein the operator is an Internet protocol (IP) PBX.

13. The application of claim 10, wherein the initiating of the phone call by the computerized mobile device to an operator is followed by examining a number that was dialed and determining its associate IVR code, by the application.

14. The application of claim 10, wherein the application is allowing a user to select an option from at least one of: (i) the voice menu; and (ii) the graphical interface, to navigate through the IVR code.

15. The application of claim 10, wherein the application is further transmitting the option that was selected to the operator.

16. The application of claim 10, wherein the application is further transferring entered data or saved data from the application to the operator.

17. The application of claim 10, wherein the operator is at least one of: (i) Public Switch Telephone Network (PSTN); and (ii) Public Branch Exchange (PBX).

18. The application of claim 10, wherein the graphic is built from a script of the voice menu that was received from the operator and is stored on the Smartphone by a converter module.

19. The application of claim 19 further comprising a wizard to enable change of attributes of the graphical interface.

20. The application of claim 18 further comprising a module for updating the script code and change graphical interface accordingly.
